(19) United States
(12) Patent Application Publication
(10) Pub. No.: US 2002/0164203 A1
(43) Pub. Date: Nov. 7, 2002

(54) Method of fastening panels using blind fasteners with engageable drive nuts

(76) Inventor: Ralph Sewell, Long Beach, CA (US)

Correspondence Address: Edgar A. Zarins, MascoTech, Inc., 21001 Van Born Rd., Taylor, MI, 48180, US

(21) Appl. No.: 10/005,276

(22) Filed: Dec. 4, 2001

Related U.S. Application Data
(63) Continuation of application No. 60/283,226, filed on Apr. 12, 2001.

(51) Int. Cl. B23P 11/00

(52) U.S. Cl. 403/299; 29/525.05

(57) ABSTRACT

A blind fastener of the type having a fastener body, a threaded stem and a sleeve is provided with a drive nut in abutting contact with the fastener body to provide mechanical engagement between the abutting surfaces of the two elements. The underside of the drive nut includes locking elements to drivably engage the outer surface of the fastener body. The positive mechanical engagement between the two elements minimizes the build-up of tensile load applied to the stem during setting of the fastener.

### RELATED APPLICATIONS

This application claims priority from U.S. Provisional Application No. 60/283,226 filed on Apr. 12, 2001.

### BACKGROUND OF THE INVENTION

I. Field of the Invention

This invention relates to drive nut blind fasteners for use in fastening two panels together in overlapped relation and, in particular, to a drive nut and drive element for engaging the drive nut to the fastener.

II. Description of the Prior Art

Blind fasteners are used in a variety of applications in which access to the blind side surface of panels being connected together is extremely limited or in some cases not possible. For example, in the construction of aerodynamic designs, including aircraft and the like, a substantially flush surface usually is desired on the accessible side of the panels, while access to the blind side may not be possible. Application and use of such fasteners in the aerospace industry impose some of the most stringent requirements which the fasteners must meet or exceed. In particular, the fasteners must securely fasten the panels but resist losing their gripping power under the stresses and vibrations imposed upon them by the harsh environment in which they are used.

One type of blind fastener that satisfies these requirements comprises an internally threaded fastener body for insertion into aligned holes of the two panels, and an externally threaded cylindrical stem passing in threaded engagement through the fastener body. The inserted end of the stem has an enlarged stem head, and the outer end of the stem has a wrench engaging portion. Upon turning motion of the stem relative to the fastener body, the stem is moved in an axial outward direction through the fastener body. This axial outward movement causes a deformable sleeve around the stem and abutting against the stem head to deform around the fastener body to a fully set condition against the inner panel. The stem further may be provided with a localized weakened region or break groove adapted to shear the stem at a predetermined torque. The break groove preferably is located axially along the stem such that the stem twists off in substantially flush relation to the outer portion of the fastener body, i.e., the fastener body head, after the fastener is fully set. In actual practice, the stem twists off within a range between approximately one-eighth of an inch above or below the outer surface of the fastener body head. The fastener body head normally is received in a countersunk, flush relationship to the outer panel, thus providing an aerodynamic surface after the fastener is set. A protruding fastener body head also may be used to engage the outer panel.

When using blind fasteners for securing panels together, as described above, a drive nut threaded on the outer portion of the stem may be provided for abutting contact with the fastener body head and gripping by an installation tool to hold it and the fastener body against rotation. When setting the fastener, slippage of the drive nut on the fastener body head occurs during rotation of the stem. With the relatively smooth surfaces of the drive nut and the fastener body head abutting, they tend to overtighten and jam together. As a result, relative turning slippage between them in a tightening direction is accommodated by elastic extension of the stem in the region gripped between the drive nut and the fastener body. This extension tends to develop a tensile load in the stem which, when added to the torsional load already acting on the stem from rotating the stem in a tightening direction, can cause the stem to twist off before the fastener is completely set and, therefore, undesirably subtract from the effective clamping force exerted by the fastener on the panels.

One example of a blind fastener with means for drivably engaging the fastener is shown in U.S. Pat. No. 4,747,002 to Beals which illustrates a specialized drive nut having a plurality of teeth formed on a lateral surface of the nut. Upon mounting the drive nut to the threaded stem, the drive nut teeth will engage corresponding notches formed in the outer surface of the fastener body. However, forming the specialized surfaces of the drive nut and fastener increases the cost of manufacturing the fastener.

### SUMMARY OF THE PRESENT INVENTION

The present invention overcomes the disadvantages of the prior known blind fasteners by providing a separate drive element disposed between the drive nut and the fastener to lockingly engage the drive nut as the stem is rotated to set the fastener.

The present invention comprises a blind fastener having an internally threaded fastener body, an externally threaded stem, a deformable sleeve, a drive nut and means of providing positive mechanical engagement between the drive nut and the fastener body. Upon rotation of the stem to set the fastener, the drive nut cooperates with the drive element to create a positive mechanical engagement between the drive nut and fastener body, thereby resisting overtightening and jamming, and preventing the build-up of unacceptably high tensile load in the stem. The blind fastener of this invention furthermore is intended to be simple to install, reliable in use, and relatively inexpensive to manufacture.

In one embodiment of the invention, the drive element includes a lock washer for deforming into the indentations, providing positive mechanical engagement between the drive nut and the fastener body and at the same time elastically compressing while the drive nut is tightened against the lock washer and in turn, the fastener body thus allowing the thread lead in the nut to find and align perfectly with the thread lead in the fastener body. At this point, the fastener body and the drive nut are prevented from rotating independently of each other and the stem is free to rotate within this assembly.

The positive mechanical engagement in combination with the axial compliance of the drive element between the drive nut and the fastener body head created by the drive element helps prevent overtightening and jamming of the drive nut against the fastener body head. This minimizes the buildup of tensile load in the stem in the region gripped between the drive nut and fastener body head. As a result, the stem is not subjected to unacceptable tensile loads that could cause it to twist off prematurely before the fastener is fully set.

The method of fastening panels using the fastener of this invention comprises the steps of inserting the fastener through the aligned openings in the panels until the fastener body head engages an outer surface of the outer panel, with the sleeve positioned beyond the inner surface of the inner panel. An installation tool is applied to grip the drive nut and hold it against rotation, while applying torque to the outer region of the stem to turn it in one direction until the sleeve has been bulged laterally to a fully set condition in overlying contact with the inner surface of the inner panel. The method further includes deforming the deformable surface on the underside of the drive nut against the irregular surface on the outer surface of the fastener body head to provide the positive engagement between the drive nut and the fastener body head during turning motion of the stem to set the fastener, as described above. If desired, the manufacturer may pre-deform the deformable surface on the drive nut against the irregular surface on the fastener body head during assembly of the fastener.

Other objects, features and advantages of the present invention will become apparent from the following detailed description, taken in conjunction with the accompanying drawings, which illustrate, by way of example, the principles of the invention.

### BRIEF DESCRIPTION OF THE DRAWINGS

The present invention will be more fully understood by reference to the following detailed description of a preferred embodiment of the present invention when read in conjunction with the accompanying drawing, in which like reference characters refer to like parts throughout the views and in which:

FIG. 1 generally illustrates a cross-sectional view of a blind fastener positioned within the panels;

FIGS. 2 through 7 illustrate alternative embodiments employed to lock the drive nut to the fastener sleeve.

### DETAILED DESCRIPTION OF THE PREFERRED EMBODIMENTS

As shown in the exemplary drawings, the present invention is embodied in a blind fastener, generally referred to by the reference numeral 10, for use in connecting two panels together in overlapped outer and inner relation. The fastener is provided with means for providing positive mechanical engagement between the drive nut and a fastener body to resist overtightening and jamming between the two elements during setting of the fastener. The blind fastener of the present invention furthermore is intended to be simple to install, reliable in use and relatively inexpensive to manufacture.

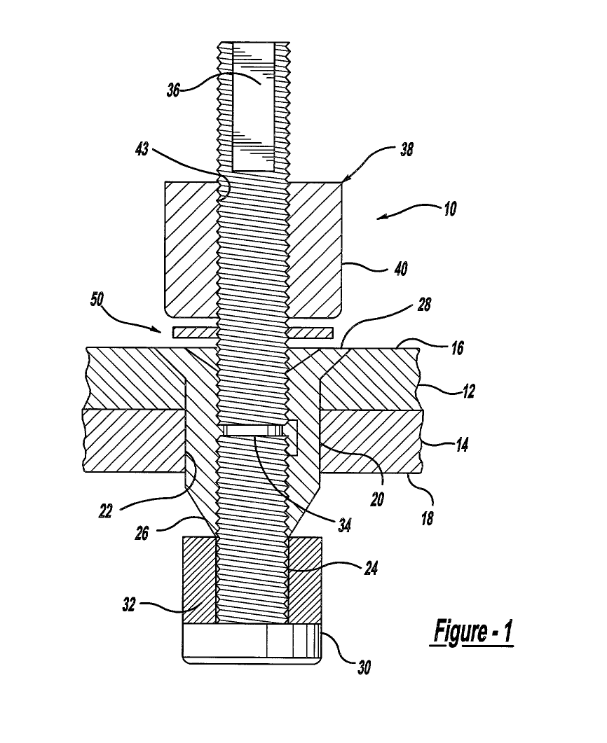

Referring to FIG. 1, the blind fastener 10 of the present invention is shown in position for connecting two panels 12 and 14 together in overlapped outer and inner relation, with the outer panel 12 having an accessible outer surface 16 and the inner panel 14 having an inaccessible or blind inner surface 18. The fastener comprises an internally threaded, generally tubular fastener body 20 received within aligned opening 22 in the two panels, and an externally threaded cylindrical stem 24 passing in threaded engagement through the fastener body. The fastener body has a tapered nose 26 projecting inwardly beyond the inner surface of the inner panel, and an enlarged body head 28 received in a substantially flush, countersunk relationship to the outer surface of the outer panel. Enlarged body heads of the non-flush, protruding head type also may be used. The stem has an enlarged head 30 at its inserted or inner end for abutment with a substantially cylindrical, deformable sleeve 32. The outer dimensions of the fastener body, stem head and sleeve are substantially the same, but are slightly less than the diameters of the holes in the two panels. This sizing of the fastener permits insertion of the fastener through the holes in the two panels to enable the fastener to perform its clamping function on the blind side, as explained in more detail below. Alternatively, the fastener may be sized to provide an interference fit between the fastener and the aligned holes in the panels.

To set the fastener 10 and clamp the two panels 12 and 14 together, the stem 24 is turned in one direction relative to the fastener body 20. This turning motion causes the stem to move in an axial outward direction through the fastener body. As the stem is moved axially outwardly, the stem head 20 forces the deformable sleeve 32 into engagement with the tapered nose 26 and over the fastener body. Although the sleeve is shown as being a separate element, it may be formed as an integral part of the fastener body. After the stem has been moved axially a certain distance, the sleeve will be fully set against the inner surface 18 of the inner panel 14 forming a secure connection between the two workpieces. If desired, a localized weakened region or break-groove 34 may be provided at an axial location along the stem and adapted to shear the stem at a point substantially flush with the fastener body head 28, after the fastener is fully set. In most cases, the stem will twist off within a range of approximately one-eighth of an inch above or below the outer surface of the fastener body head.

Turning of the stem 24 relative to the fastener body 20 to set the fastener 10 is accomplished preferably by applying a torque to the stem while holding the fastener body against rotational movement. Various conventional power driven installation tools having wrench bits may be used for setting and installing the fastener in the manner described above.

To enable turning of the stem 24, the outer end of the stem is provided with a pair of wrenching flats 36 adapted to engage the rotary wrench bit of the installation tool (not shown). Wrench engaging means other than flats 36 may be provided on the stem, as desired. To prevent turning of the fastener body 20 within the panels 12 and 14 while the stem is being turned, a drive nut 38 is mounted on the stem in abutment with the fastener body head 28. The drive nut has an outer surface 40 for engagement by a non-rotating fitting on the installation tool (not shown) and an inner surface 42 that is threaded for engagement with the externally threaded stem 24. In most tools, the non-rotating fitting is concentric with but axially spaced from the rotating wrench bit and holds the drive nut and thus the fastener body against rotation relative to the stem.

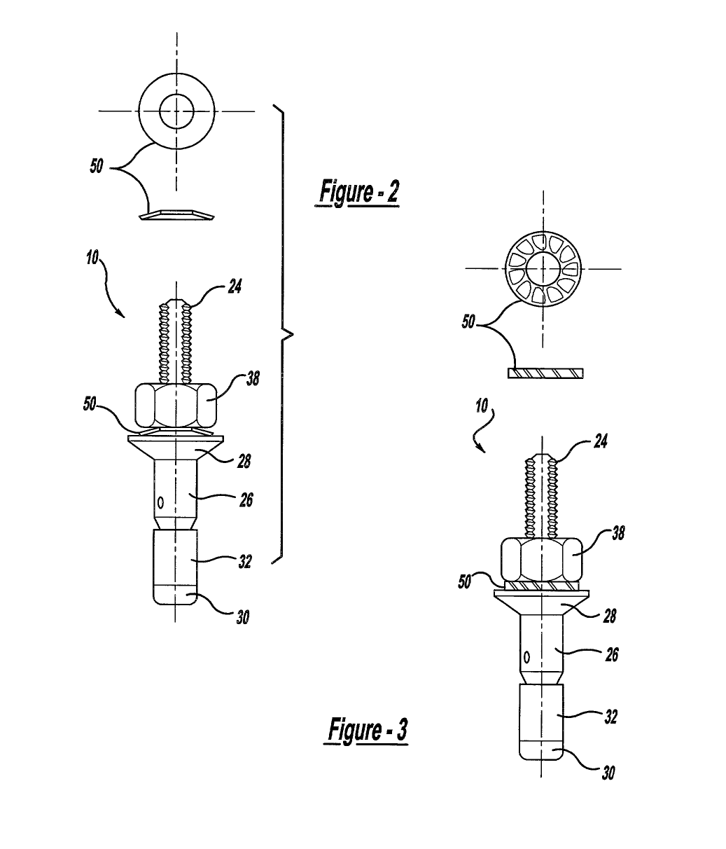

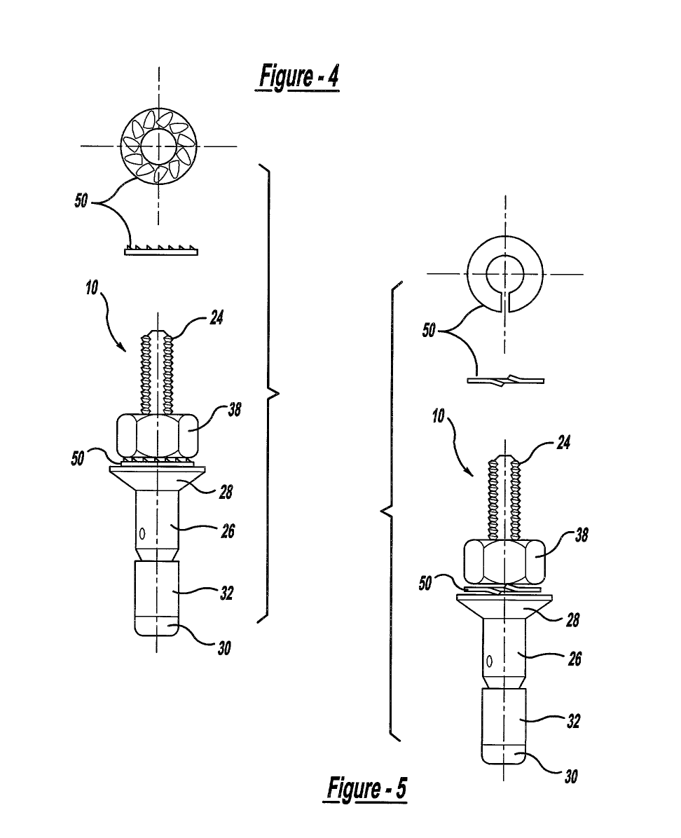

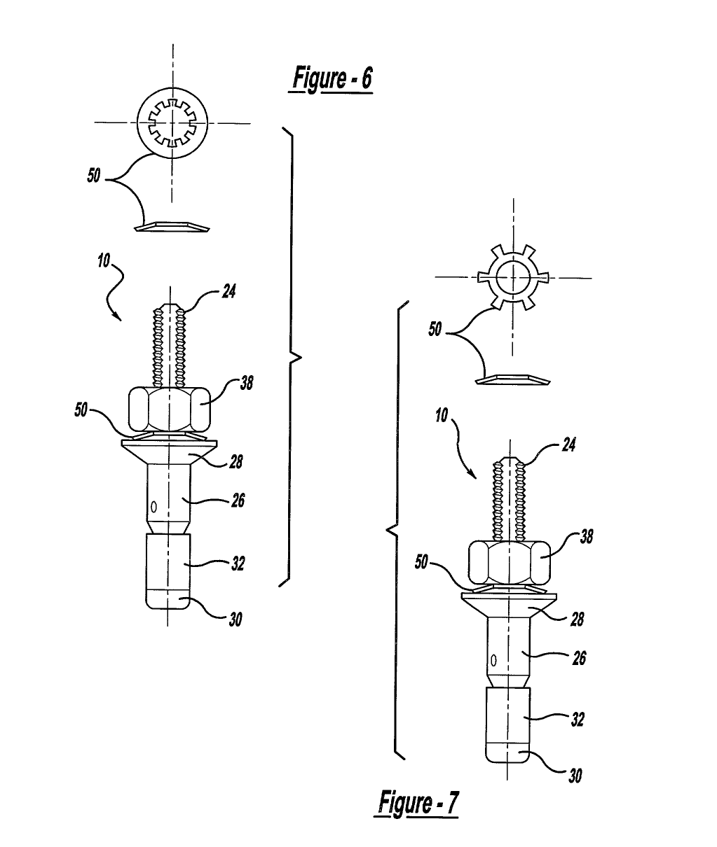

In accordance with the present invention, means are provided to create a positive mechanical engagement between the drive nut 38 and the fastener body head 28. In embodiments of the invention, illustrated in FIGS. 2-7, the drive means comprises a drive element 50 disposed between the drive nut 38 and the fastener body head 28. The drive element 50 is configured to lockingly engage the drive nut 38 to the fastener body head 28 such that upon rotating the stem 24 the drive nut 38 and fastener body 26 are maintained fixed to allow the fastener 10 to set. The present invention contemplates any form of drive element 50 which will prevent rotation of the drive nut 38 relative to the fastener head 28 and at the same time provide axial compliance to allow the drive nut to initially rotate sufficiently to align the thread lead of both elements. Illustrative drive elements 50 are shown in FIGS. 2 through 7. Generally, these drive elements 50 are in the form of lock washers having a substantially circular configuration with a central aperture 52 through which the stem 24 extends. The common component of the drive element 50 is a locking member 54 for engaging the drive nut 38 and/or the fastener body head 28. The locking member 54 may be in the form of teeth or a deformation of the drive element to create an interference with the drive nut 38 and/or the fastener body head 28 and at the same time provide axial compliance to allow the drive nut to rotate to the point that the thread leads in both the fastener body 26 and the drive nut 38 are aligned. By utilizing a separate drive element 50, the need to machine the engaging surfaces of the drive nut 38 and fastener body head 28 is eliminated. Nevertheless, the independent drive element 50 will deformably engage both the drive nut 38 and the fastener head 28 to lock the elements together.

To install the fastener 10 of the present invention, the fastener is inserted into the aligned openings 22 in the two panels 12 and 14 until the fastener body head 28 is received against the outer surface 16 of the outer panel. The installation tool is moved axially onto the fastener, with the non-rotating fitting engaging the drive nut 38 and holding it and thus the fastener body 20 against rotation, and with the rotary wrench bit engaging the wrenching flats 36 and turning the stem 24 in one direction to set the fastener. As the stem is rotated, the drive element 50 on the underside of the drive nut is urged against the outer surface of the fastener body head 28. Further turning of the stem causes increased engagement of the drive element 50 with the fastener head 28 until both a positive mechanical engagement exists between the drive nut and the fastener body head and the thread leads of both elements are aligned.

The positive mechanical engagement between the drive nut 38 and the fastener body head 28 and the thread lead alignment described above helps to minimize overtightening and jamming of the drive nut against the fastener body head. This has the effect of preventing the build-up of unacceptably high tensile load acting on the stem 24 in the region gripped between the drive nut and the fastener body head. After the fastener 10 is fully set, further rotation of the stem relative to the drive nut causes the stem to twist off at the breakgroove 34. Importantly, the stem is not subjected to unacceptable tensile loads that could cause it to twist off prematurely before the fastener is fully set. Thus, better clamp-up of the fastener is achieved.

When the outer portion of the stem 24 twist off at the breakgroove 34, the entire drive nut 38 remains attached. As explained previously, the counterbore 48 prevents the drive nut from remaining attached to the set fastener in the event of a high stem break-off. Magnetic retrieval of the twisted off stem and attached drive nut by known techniques is thus made possible.

Alternate embodiments of the drive element 50 made in accordance with the teachings of this invention are shown in FIGS. 2-7.

Regardless of which embodiment of the drive element 50 is selected, all embodiments function in substantially the same manner and deform into or around an irregular surface, on the outer surface of the fastener body head 28 and allow the thread lead alignment.

The method of fastening the panels 12 and 14 using the fastener 10 of this invention comprises the steps of inserting the fastener through the aligned openings 22 in the panels until the fastener body head 28 engages the outer surface 16 of the outer panel 12, with the sleeve 32 positioned beyond the inner surface 18 of the inner panel 14. The installation tool is applied to grip the drive nut 38 and hold it against rotation, while applying torque to the outer region of the stem 24 to turn it in one direction until the sleeve had been bulged laterally to a fully set condition in overlying contact with the inner surface of the inner panel. The method further includes the outer surface of the fastener body head to provide the positive mechanical engagement between the drive nut and the fastener body head during turning motion of the stem to set the fastener.

The foregoing detailed description has been given for clearness of understanding only and no unnecessary limitations should be understood therefrom as some modifications will be obvious to those skilled in the art without departing from the scope and spirit of the appended claims.

What is claimed is:

1. A fastener adapted to fasten overlapped inner and outer panels, said fastener received through aligned openings in the panels, said fastener comprising:
a generally tubular fastener body having an enlarged body head;
an externally threaded drive stem extending through said tubular fastener body, said drive stem having a deformable sleeve disposed at an opposite end from said body head;
a drive nut threadably mounted to said externally threaded drive stem proximate said body head; and
a drive element interposed between said drive nut and said body head, said interposed drive element locking said drive nut to said fastener body to provide a positive mechanical engagement between the drive nut and said fastener body as said stem is rotated to set said fastener.

2. The fastener as defined in claim 1 wherein said drive element is a washer having a central aperture for receiving said stem therethrough, said washer having a first face for engaging said drive nut and a second face for engaging said body head of said fastener body.

3. The fastener as defined in claim 2 wherein said washer has at least one tooth for lockingly engaging one of said drive nut and said body head.

4. The fastener as defined in claim 3 wherein said washer has radially extending teeth formed along a periphery of said washer for lockingly engaging at least one of said drive nut and said body head.

5. The fastener as defined in claim 3 wherein said washer has a plurality of teeth extending perpendicular to said washer for lockingly engaging at least one of said drive nut and said body head.

6. The fastener as defined in claim 1 wherein said drive element is axially compressible between said drive nut and said body head such that a thread lead on said drive nut aligns with a thread lead in said fastener body.

7. A method of fastening overlapped outer and inner panels using a fastener of the type having a generally tubular fastener body having an enlarged body head, an internally threaded drive nut in contact with the fastener body head for resisting rotation of the fastener body, a deformable sleeve at an opposite end of the fastener body from the bodyhead, an externally threaded drive stem extending through the drive nut in threaded engagement therewith and through aligned bores in the sleeve and the fastener body to exert force upon the sleeve to bulge it laterally upon motion of the stem in an axially outward direction relative to the fastener body caused by rotation of the stem in one direction relative to the drive nut, the method comprising the steps of:
inserting the fastener through aligned openings in the panels to be fastened together until the body head engages an outer surface of the outer panel with the sleeve positioned beyond the inner surface of the inner panel;
gripping the drive nut to hold it against rotation, while applying torque to the outer region of the stem to turn the stem in the one direction until the sleeve has been bulged laterally to a fully set condition overlying the inner surface of the inner panel; and
lockingly engaging the underside of the drive nut against the outer surface of the fastener body head to provide a positive mechanical engagement between the drive nut and the fastener body during turning motion of the stem to set the fastener.

8. The method of claim 6 wherein the step of engaging the underside of the drive nut against the outer surface of the fastener body head is performed by inserting a locking element therebetween to prevent rotation of said drive nut relative to said fastener body.

9. The method of claim 8 wherein said locking element is axially compressible to align thread leads on said drive nut and fastener body.
